(19) United States
(12) Patent Application Publication
(10) Pub. No.: US 2014/0190354 A1
(43) Pub. Date: Jul. 10, 2014

(54) DEBINDER TRAP

(71) Applicant: CHENG UEI PRECISION INDUSTRY CO., LTD., New Taipei City (TW)

(72) Inventors: Cheng Yu Chou, New Taipei City (TW); Che Wei Hsu, New Taipei City (TW); Cheng An Chiang, New Taipei City (TW); Chih Wei Cheng, New Taipei City (TW)

(73) Assignee: CHENG UEI PRECISION INDUSTRY CO., LTD., New Taipei City (TW)

(21) Appl. No.: 13/734,894

(22) Filed: Jan. 4, 2013

(51) Int. Cl. B01D 53/00

(52) U.S. Cl. CPC B01D 53/002
USPC 96/221

(57) ABSTRACT

A debinder trap for treating binder gas thermal-cracked in sintering process of metal injection molding includes a barrel body defining an inflow hole, a drain hole, an inlet and an outlet, baffles disposed in the barrel body to define a guide channel of which entrance and exit are communicated with the inlet and the outlet, and a temperature controller containing liquid material therein and connected with the barrel body via an inflow pipe and a drain pipe connecting in the inflow hole and the drain hole. An accommodating channel passes through the inside of the barrel body and extends from the inflow hole to the drain hole. The temperature controller conveys the liquid material in the accommodating channel to regulate internal environment of the barrel body into low-temperature to condense the binder gas through the guide channel into solid, and high-temperature to make the solid binder molten to sink.

### BACKGROUND OF THE INVENTION

1. Field of the Invention

The present invention generally relates to a debinder trap used in the process of metal injection molding, and more particularly to a debinder trap having a simple structure and a good effect of treating binder gas thermal-cracked in sintering process of the metal injection molding.

2. The Related Art

Metal injection molding is a metalworking process where finely-powdered metal is mixed with a measured amount of binder material to comprise a feedstock capable of being handled by plastic processing equipment through a process known as injection mold forming. Subsequent conditioning operations are performed on the molded shape, where the binder material is removed and metal particles are coalesced into the desired state for the metal alloy. In detail, the binder material is thermal-cracked into binder gas in sintering process of the metal injection molding. When the binder gas is directly pumped by a vacuum pump, it will severely impair the vacuum pump on account of the binder gas being condensed to accumulate in the vacuum pump and deteriorate lubrication oil, etc. Therefore, in order to protect the vacuum pump, a debinder trap is used to treat the binder gas.

At present, the debinder trap generally utilizes two debinder containers and two debinder barrels to condense the binder gas into solid for being adhered on inner walls thereof so as to be treated some time later. Moreover, four valve bodies are needed to control the debinder containers and the debinder barrels respectively. As a result, the conventional debinder trap has too many parts and complicated working process. On the side, it is difficult to manually clean the solid binder from the inner walls of the debinder containers and the debinder barrels, so that results in a poor effect of treating the binder gas when next using the debinder trap, and most of the binder gas further passes through the debinder trap into the vacuum pump. It will impair the vacuum pump over again. So, it is required that a debinder trap has a simple structure and can effectively treat the binder gas thermal-cracked in the sintering process of the metal injection molding.

### SUMMARY OF THE INVENTION

An object of the present invention is to provide a debinder trap for treating binder gas thermal-cracked in sintering process of metal injection molding. The debinder trap includes a hollow barrel body, a plurality of baffles and a temperature controller containing liquid material therein. The barrel body has a barrel cover, a barrel wall and a barrel bottom. The outer face of the barrel wall defines an inflow hole and a drain hole. An inlet and an outlet are apart opened in the barrel cover and penetrate through the barrel cover. The baffles are disposed in the barrel body to define a guide channel of which the entrance is communicated with the inlet of the barrel body and the exit is communicated with the outlet of the barrel body.

The temperature controller is connected with the barrel body via an inflow pipe and a drain pipe connecting in the inflow hole and the drain hole respectively. An accommodating channel passes through the inside of the barrel body and extends from the inflow hole to the drain hole. The temperature controller regulates the temperature of the liquid material between a low temperature and a high temperature to change internal environment of the barrel body into low-temperature or high-temperature, by virtue of conveying the liquid material into the accommodating channel through the inflow pipe and further flowing the liquid material back through the drain pipe to form a circulation flow.

In use, the binder gas enters the barrel body through the inlet and flows along the guide channel to be condensed into solid binder and attached to inner faces of the barrel body and the baffles by the low-temperature environment, and then the solid binder is molten to sink on the barrel bottom by the high-temperature environment to keep the inner faces of the barrel body and the baffles clean before next using the debinder trap.

As described above, the debinder trap of the present invention defines the guide channel to guide the binder gas to flow therethrough, and utilizes the temperature controller to regulate the internal environment of the barrel body into low-temperature so as to condense the binder gas into solid, and regulate the internal environment of the barrel body into high-temperature so as to make the solid binder molten to sink on the barrel bottom, so that keeps the inner faces of the barrel body and the baffles clean before next using the debinder trap and further makes the debinder trap have a good effect of treating the debinder gas in next use. Furthermore, the debinder trap has a simple structure.

### BRIEF DESCRIPTION OF THE DRAWINGS

The present invention will be apparent to those skilled in the art by reading the following description, with reference to the attached drawings, in which:

FIG. 1 is a perspective view of a debinder trap according to the present invention;

FIG. 2 is a partially perspective sectional view of the debinder trap of FIG. 1;

FIG. 3 is a cross-sectional view of the debinder trap according to one embodiment of the present invention; and

FIG. 4 is a cross-sectional view of the debinder trap according to another embodiment of the present invention.

### DETAILED DESCRIPTION OF THE PREFERRED EMBODIMENT

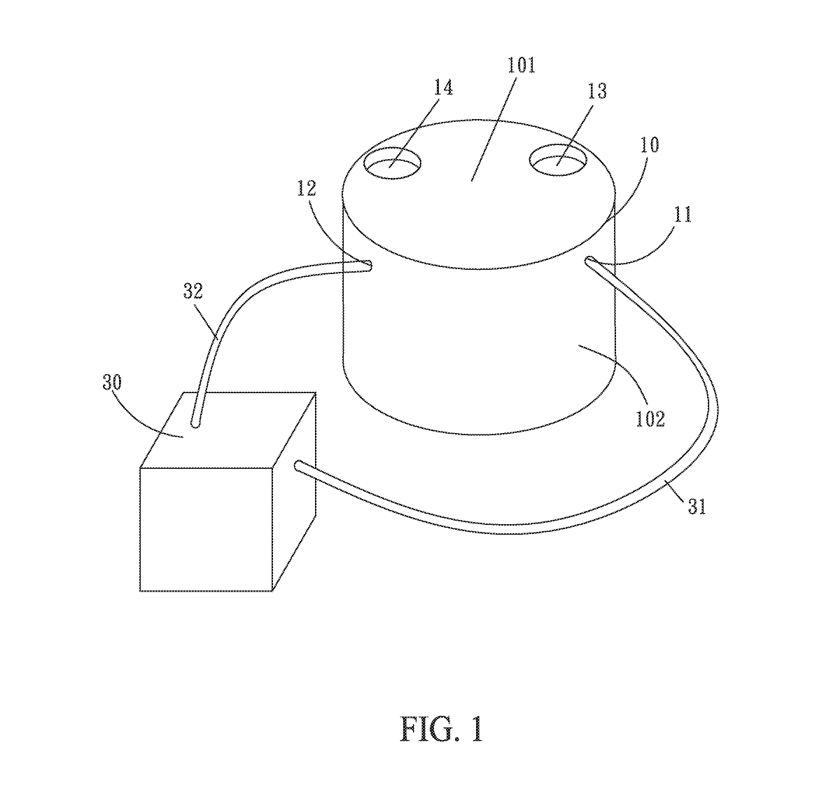

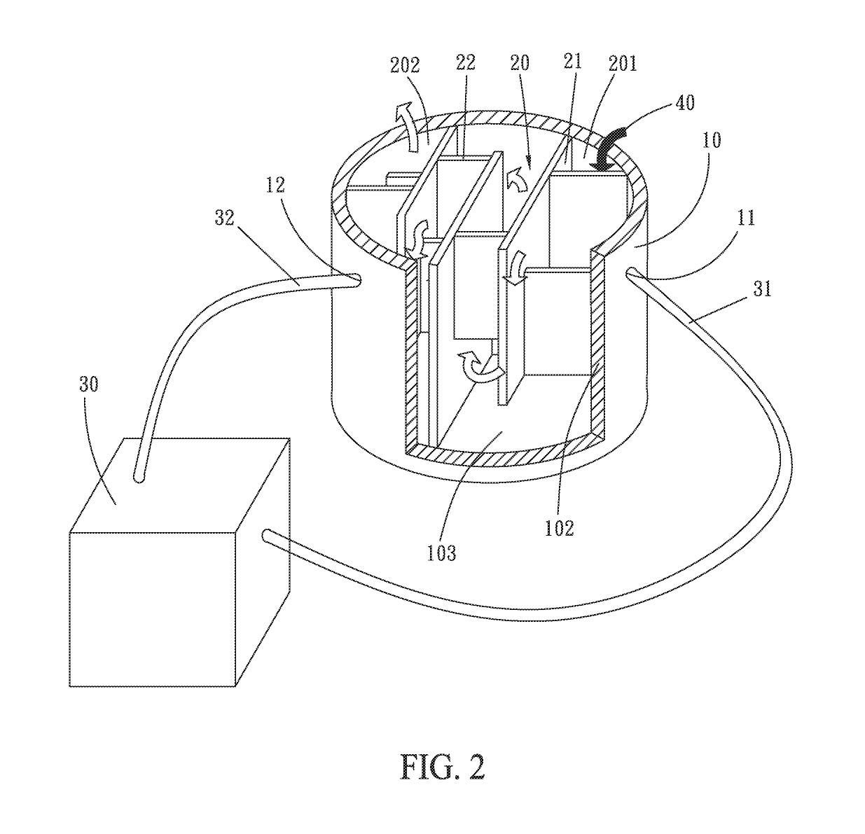

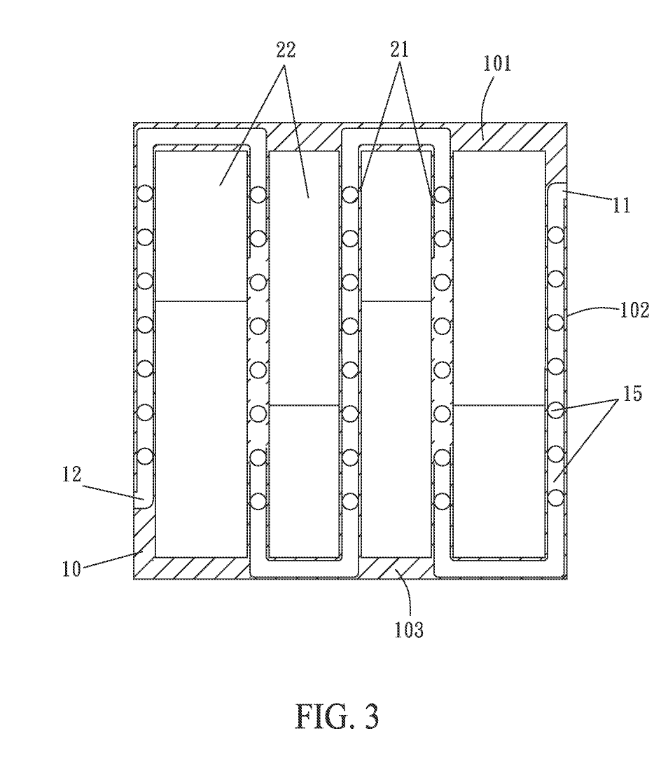

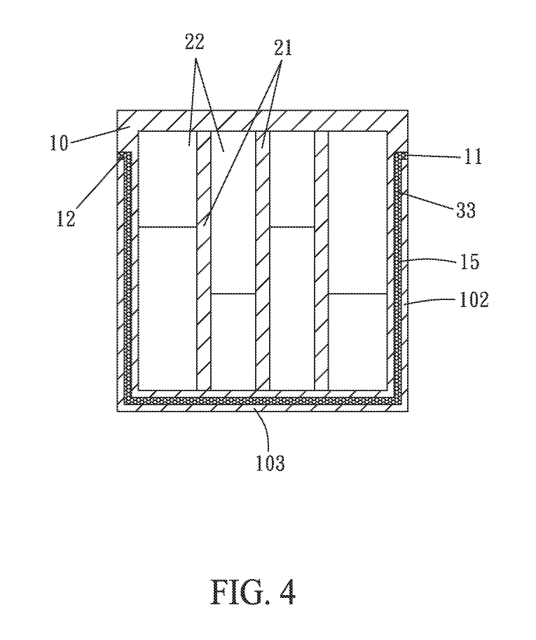

With reference to FIG. 1, FIG. 2, FIG. 3 and FIG. 4, a debinder trap in accordance with the present invention is used for treating binder gas 40 thermal-cracked in sintering process of metal injection molding. The debinder trap includes a hollow barrel body 10, a plurality of baffles and a temperature controller 30 containing liquid material 33 therein.

The barrel body 10 has a barrel cover 101, a barrel wall 102 and a barrel bottom 103. The outer face of the barrel wall 102 defines an inflow hole 11 and a drain hole 12. An inlet 13 and an outlet 14 are apart opened in the barrel cover 101 and penetrate through the barrel cover 101. The baffles are disposed in the barrel body 10 to define a guide channel 20 of which the entrance 201 is communicated with the inlet 13 of the barrel body 10 and the exit 202 is communicated with the outlet 14 of the barrel body 10.

The temperature controller 30 is connected with the barrel body 10 via an inflow pipe 31 and a drain pipe 32 connecting in the inflow hole 11 and the drain hole 12 respectively. An accommodating channel 15 passes through the inside of the barrel body 10 and extends from the inflow hole 11 to the drain hole 12. The temperature controller 30 regulates the temperature of the liquid material 33 between a low temperature and a high temperature to change internal environment of the barrel body 10 into low-temperature or high-temperature, by virtue of conveying the liquid material 33 into the accommodating channel 15 through the inflow pipe 31 and further flowing the liquid material 33 back through the drain pipe 32 to form a circulation flow.

In use, the binder gas 40 enters the barrel body 10 through the inlet 13 and flows along the guide channel 20 to be condensed into solid binder and attached to inner faces of the barrel body 10 and the baffles by the low-temperature environment. After the sintering process is finished, the solid binder is molten to sink on the barrel bottom 103 by the high-temperature environment to keep the inner faces of the barrel body 10 and the baffles clean before next using the debinder trap.

Referring to FIG. 2, FIG. 3 and FIG. 4 again, the baffles include a plurality of longitudinal baffles 21 and a plurality of transverse baffles 22. The longitudinal baffles 21 apart parallel to one another and vertically connect the barrel cover 101 and the barrel bottom 103. Each of the longitudinal baffles 21 has one side edge connected with the barrel wall 102 and the other side edge spaced from the barrel wall 102. The longitudinal baffles 21 are alternately arranged to make the guide channel 20 show continuous S-shape from a vertical view. The transverse baffles 22 are vertically and perpendicularly connected between each two adjacent longitudinal baffles 21 and between outmost two longitudinal baffles 21 and the barrel wall 102. The transverse baffles 22 are alternately arranged with one transverse baffle 22 having the top edge connected with the barrel cover 101 and the bottom edge away from the barrel bottom 103, and neighboring transverse baffle 22 having the top edge away from the barrel cover 101 and the bottom edge connected with the barrel bottom 103, to make the guide channel 20 show continuous S-shape from a lateral view. So, the guide channel 20 can guide the binder gas 40 to flow and make good contact with the inner faces of the barrel cover 101, the barrel wall 102 and the barrel bottom 103 of the barrel body 10 and the baffles 21, 22 so as to effectively treat the binder gas 40.

In this invention, the transverse baffle 22 near to the inlet 13 has the top edge connected with the barrel cover 101 and the bottom edge away from the barrel bottom 103. The entrance 201 of the guide channel 20 is surrounded by the transverse baffle 22, the inner wall 102, a part of the outmost longitudinal baffle 21 connected with the inner wall 102, and a part of the barrel cover 101 opened with the inlet 13.

In this invention, the liquid material 33 may be oil material or water material. The temperature controller 30 regulates the temperature of the liquid material 33 between the low temperature of 10 to 20 degrees and the high temperature of 80 to 90 degrees.

Referring to FIG. 3, it shows one embodiment of the debinder trap of the present invention. In this embodiment, the accommodating channel 15 passes through the insides of the barrel cover 101, the barrel wall 102 and the barrel bottom 103 of the barrel body 10 and further passes through the insides of the baffles 21, 22 to be interlinked from the inflow hole 11 to the drain hole 12. Referring to FIG. 4, it shows another embodiment of the debinder trap of the present invention. In this embodiment, the accommodating channel 15 only passes through the insides of the barrel wall 102 and the barrel bottom 103 of the barrel body 10 and is interlinked from the inflow hole 11 to the drain hole 12.

As described above, the debinder trap of the present invention defines the guide channel 20 to guide the binder gas 40 to flow and make good contact with the inner faces of the barrel body 10 and the baffles 21, 22 so as to effectively treat the binder gas 40. Moreover, the debinder trap utilizes the temperature controller 30 to regulate the internal environment of the barrel body 10 into low-temperature so as to condense the binder gas 40 into solid, and regulate the internal environment of the barrel body 10 into high-temperature so as to make the solid binder molten to sink on the barrel bottom 103, so that keeps the inner faces of the barrel body 10 and the baffles 21, 22 clean before next using the debinder trap and further makes the debinder trap have a good effect of treating the debinder gas 40 in next use. And the debinder trap has a simple structure.

What is claimed is:

1. A debinder trap for treating binder gas thermal-cracked in sintering process of metal injection molding, comprising:
a hollow barrel body having a barrel cover, a barrel wall and a barrel bottom, the outer face of the barrel wall defining an inflow hole and a drain hole, an inlet and an outlet being apart opened in the barrel cover and penetrating through the barrel cover;
a plurality of baffles disposed in the barrel body to define a guide channel of which the entrance is communicated with the inlet of the barrel body and the exit is communicated with the outlet of the barrel body; and
a temperature controller containing liquid material therein, the temperature controller being connected with the barrel body via an inflow pipe and a drain pipe connecting in the inflow hole and the drain hole respectively, an accommodating channel passing through the inside of the barrel body and extending from the inflow hole to the drain hole, the temperature controller regulating the temperature of the liquid material between a low temperature and a high temperature to change internal environment of the barrel body into low-temperature or high-temperature, by virtue of conveying the liquid material into the accommodating channel through the inflow pipe and further flowing the liquid material back through the drain pipe to form a circulation flow;
wherein the binder gas enters the barrel body through the inlet and flows along the guide channel to be condensed into solid binder and attached to inner faces of the barrel body and the baffles by the low-temperature environment, and then the solid binder is molten to sink on the barrel bottom by the high-temperature environment to keep the inner faces of the barrel body and the baffles clean before next using the debinder trap.

2. The debinder trap as claimed in claim 1, wherein the baffles include a plurality of longitudinal baffles and a plurality of transverse baffles, the longitudinal baffles apart parallel to one another and vertically connect the barrel cover and the barrel bottom, each of the longitudinal baffles has one side edge connected with the barrel wall and the other side edge spaced from the barrel wall, the longitudinal baffles are alternately arranged to make the guide channel show continuous S-shape from a vertical view, the transverse baffles are vertically and perpendicularly connected between each two adjacent longitudinal baffles and between outmost two longitudinal baffles and the barrel wall, the transverse baffles are alternately arranged with one transverse baffle having the top edge connected with the barrel cover and the bottom edge away from the barrel bottom, and neighboring transverse baffle having the top edge away from the barrel cover and the bottom edge connected with the barrel bottom, to make the guide channel show continuous S-shape from a lateral view.

3. The debinder trap as claimed in claim 2, wherein the transverse baffle near to the inlet has the top edge connected with the barrel cover and the bottom edge away from the barrel bottom, the entrance of the guide channel is surrounded by the transverse baffle, the inner wall, a part of the outmost longitudinal baffle connected with the inner wall, and a part of the barrel cover opened with the inlet.

4. The debinder trap as claimed in claim 1, wherein the accommodating channel passes through the insides of the barrel cover, the barrel wall and the barrel bottom of the barrel body and further passes through the insides of the baffles to be interlinked from the inflow hole to the drain hole.

5. The debinder trap as claimed in claim 1, wherein the liquid material is oil material or water material.

6. The debinder trap as claimed in claim 1, wherein the temperature controller regulates the temperature of the liquid material between the low temperature of 10 to 20 degrees and the high temperature of 80 to 90 degrees.
